(19) United States
(12) Patent Application Publication
(10) Pub. No.: US 2021/0039404 A1
(43) Pub. Date: Feb. 11, 2021

(54) PRINTER

(71) Applicants: CITIZEN WATCH CO., LTD., Tokyo (JP); CITIZEN SYSTEMS JAPAN CO., LTD., TOKYO (JP)

(72) Inventor: Hirotaka KAMIYA, Nagano (JP)

(21) Appl. No.: 16/968,136

(22) PCT Filed: Jan. 24, 2019
(86) PCT No.: PCT/JP2019/002373

§ 371 Date: Aug. 6, 2020

(30) Foreign Application Priority Data
Feb. 27, 2018 (JP) 2018-033295

(51) Int. Cl. B41J 11/66

(52) U.S. Cl. CPC B41J 11/663

(57) ABSTRACT

The printer transports belt-like continuous paper including predefined print regions disposed in a longitudinal direction thereof, detects marks disposed on the continuous paper in the longitudinal direction and respectively corresponding to the print regions, prints on the print regions of the continuous paper, and cuts the continuous paper at an edge of the print regions to discharge a printed portion of the continuous paper as a printed sheet, the edge being a trailing edge with respect to a discharging direction of the continuous paper. The printer stores information on a positional relationship between the marks and the print regions on the continuous paper, controls a transporting device so that the transporting device transports the continuous paper in accordance with the positional relationship using a detected one of the marks as a reference position, thereby positioning one of the print regions at a printing device, and then repeatedly transports the continuous paper in one direction and an opposite direction by the same amount during printing. The printer prints in a different color on the one of the print regions every time the continuous paper is transported in the one direction, thereby forming a color image.

### FIELD

The present invention relates to a printer.

### BACKGROUND

Some types of belt-like continuous paper (e.g., rolled paper) used in a printer as a recording medium for printing are provided with tear-off lines (e.g., perforated lines) in advance so that a printed region of the continuous paper can be easily cut off. For example, Japanese Unexamined Patent Publication No. 9-323484 describes a method of forming an image on such continuous paper (a roll-shaped image receiving sheet for thermal transfer printing). In this method, when a detection mark on the image receiving sheet indicating a starting position for image formation is detected by a detector in a printer, transport of the image receiving sheet is stopped, and registration of the image receiving sheet is performed for image formation, and a color image is then formed by dye-sublimation thermal transfer printing. The detection of the detection mark and the registration are repeated three times to superpose yellow, magenta and cyan images on top of one another.

### SUMMARY

For example, if belt-like continuous paper including print regions which are predefined by tear-off lines and disposed in a longitudinal direction of the paper is used as a recording medium, it is necessary to form images so that they are fitted into the print regions. In this case, the continuous paper may be cut, for example, in the middle of a print region, and the leading edge of the continuous paper may not necessarily be the same as that of the foremost print region; thus, if the leading edge of the continuous paper is used as a reference, each print region may not be accurately positioned at a printing device. For this reason, it is desired to perform positioning of the print regions using marks on the continuous paper which respectively correspond to the print regions as reference positions. However, if one of the marks on the continuous paper is detected and positioning of the paper is performed using the detection result for each of colors to be superposed, it is difficult to accurately superpose images of different colors on top of one another because detection timings may differ between the colors due to, for example, slack in the transported continuous paper.

It is an object of the present invention to provide a printer forming a color image accurately on a print region predefined on belt-like continuous paper.

Provided is a printer including: a transporting device configured to transport belt-like continuous paper including predefined print regions disposed in a longitudinal direction thereof; a detector configured to detect marks disposed on the continuous paper in the longitudinal direction, the marks respectively corresponding to the print regions; a printing device configured to print on the print regions of the continuous paper; a cutter configured to cut the continuous paper at an edge of the print regions to discharge a printed portion of the continuous paper as a printed sheet, the edge being a trailing edge with respect to a discharging direction of the continuous paper; a memory configured to store information on a positional relationship between the marks and the print regions on the continuous paper; and a controller configured to control the transporting device so that the transporting device transports the continuous paper in accordance with the positional relationship using a detected one of the marks as a reference position, thereby positioning one of the print regions at the printing device, and then repeatedly transports the continuous paper in one direction and an opposite direction by the same amount during printing, wherein the printing device prints in a different color on the one of the print regions every time the continuous paper is transported in the one direction, thereby forming a color image.

In the printer, it is preferred that the memory be configured to store information on the positional relationship for each of different types of the continuous paper, the positional relationship depending on shapes, sizes or arrangement of the print regions on the continuous paper, and that the controller be configured to refer to the information on the positional relationship of the continuous paper transported by the transporting device to control operation of the transporting device.

After printing performed by the printing device, the controller preferably further causes the transporting device to transport the continuous paper in accordance with the positional relationship using a newly detected mark as a reference position, thereby positioning the trailing edge of the one of the print regions at the cutter.

It is preferred that the detector be also capable of detecting an edge of the continuous paper, the edge being a leading edge with respect to the discharging direction, and that if none of the marks is detected while the transporting device transports the continuous paper by a predetermined amount, the controller cause the transporting device to transport the continuous paper in accordance with the positional relationship using the leading edge of the continuous paper as a reference position, thereby positioning one of the print regions at the printing device.

After printing performed by the printing device, the controller preferably further causes the transporting device to transport the continuous paper in accordance with the positional relationship using an edge of the one of the print regions as a reference position, thereby positioning the trailing edge of the one of the print regions at the cutter, regardless of whether or not a mark has been newly detected.

If none of the marks is detected while the transporting device transports the continuous paper by a predetermined amount, the controller preferably causes the transporting device to transport the continuous paper in accordance with the positional relationship using an edge of the one of the print regions as a reference position, thereby positioning the trailing edge of the one of the print regions at the cutter.

If none of the marks is detected while the transporting device transports the continuous paper by the predetermined amount, the controller preferably notifies a user that printing has been performed without a mark being detected.

The above printer can form a color image accurately on a print region predefined on belt-like continuous paper.

### BRIEF DESCRIPTION OF DRAWINGS

FIG. 1 is a cross-sectional view schematically showing the configuration of a printer 1.

FIG. 2A is a first diagram showing paper 10:

FIG. 2B is a second diagram showing the paper 10:

FIG. 3 shows an ink ribbon 4;

FIG. 4 is a first diagram showing a first operational example of the printer 1;

FIG. 5 is a second diagram showing the first operational example of the printer 1:

FIG. 6 is a flowchart showing the first operational example of the printer 1;

FIG. 7 is a first diagram showing a second operational example of the printer 1:

FIG. 8 is a second diagram showing the second operational example of the printer 1; and

FIG. 9 is a flowchart showing the second operational example of the printer 1.

### DESCRIPTION OF EMBODIMENTS

Hereinafter, a printer will be described with reference to the accompanying drawings. However, it should be noted that the present invention is not limited to the drawings or the embodiments described below.

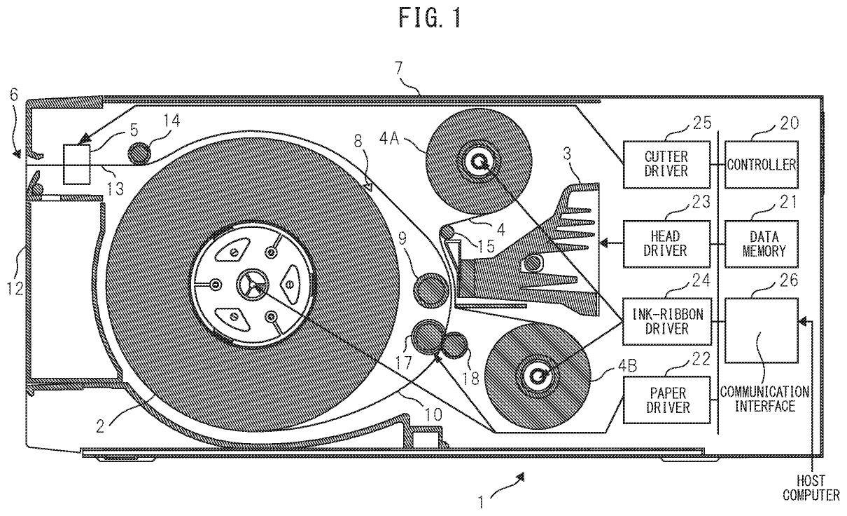

FIG. 1 is a cross-sectional view schematically showing the configuration of a printer 1. The printer 1 is a thermal transfer printer (dye-sublimation color printer) which transfers ink carried on an ink ribbon 4 onto continuous paper 10 to form (print) an image. Of the components included in the printer 1. FIG. 1 shows only those indispensable for explanation, and the other components are omitted from the illustration.

The major components of the printer 1 include a rolled-paper holder 2, a thermal head 3, a ribbon supply roller 4A, a ribbon take-up roller 4B, a cutter 5, a paper sensor 8, a platen roller 9, an exit roller 14, a ribbon guide roller 15, a grip roller 17, a pinch roller 18, a controller 20, a data memory 21, a paper driver 22, a head driver 23, an ink-ribbon driver 24, a cutter driver 25 and a communication interface 26. These components are disposed in a cabinet 7.

The rolled-paper holder 2 holds thereon the paper 10 wound into a roll. The paper 10 may be made of any material without limitation, as long as it can be used by a printer. The rolled-paper holder 2 is driven by the paper driver 22 in the forward or backward direction, and thereby rotates around the center axis thereof. The rotation of the rolled-paper holder 2 in the forward direction causes the paper 10 to pass between the thermal head 3 and the platen roller 9 and to be transported toward an exit port 6. The rotation of the rolled-paper holder 2 in the backward direction rewinds the paper 10 onto the rolled-paper holder 2.

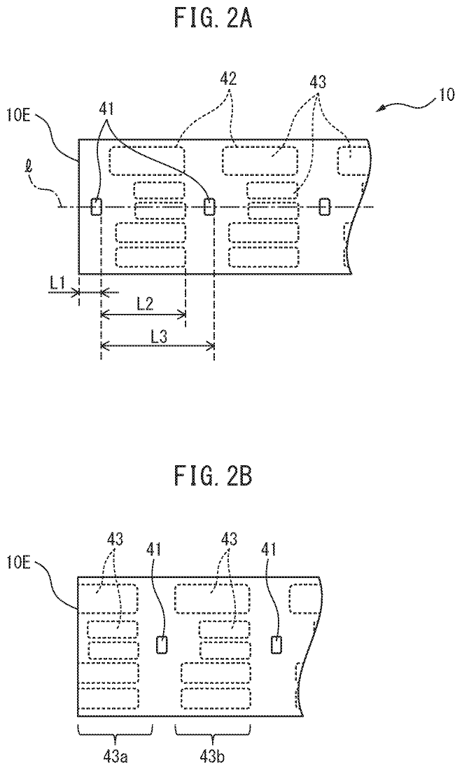

FIGS. 2A and 2B show an example of the paper 10. The left side of each figure is the leading edge 10E of the paper, and the right side thereof is the side where the rolled-paper holder 2 is placed. As shown in FIG. 2A, on the paper 10, detection holes 41 and sets of tear-off regions 43 are repeatedly disposed at regular intervals in the longitudinal direction of the paper.

The detection holes 41, which are an example of the marks, are small rectangular through-holes to be detected by the paper sensor 8 for positioning the tear-off regions 43 at the time of printing. Since the paper sensor 8 of the printer 1 is disposed on a dashed and dotted center line 1 which is equidistant from the lateral sides of the paper 10, the detection holes 41 are formed on this center line similarly to the paper sensor 8. If the paper sensor is disposed, for example, above one of the side edges of the continuous paper, unlike the paper sensor 8 of the printer 1, the detection holes 41 may also be formed on this side edge. The marks on the continuous paper are not limited to rectangular through-holes, and may be, for example, black marks formed on the back surface of the paper or notches formed on one of the side edges of the paper.

The tear-off regions 43, which are an example of the print regions, are regions on the paper 10 encircled by tear-off lines 42. The tear-off lines 42 are perforated lines or score lines formed by, for example, cutting the paper 10 linearly and discontinuously, or cutting non-pierced grooves in the paper 10, and are provided in order for a printed region of the paper 10 to be easily cut off. For example, the paper 10 may be peelable label paper (sticker paper), and in this case, the tear-off regions 43 can be peeled off from the paper 10 and used as stickers.

In the paper 10, five rectangular tear-off regions 43 arrayed in the width direction thereof form one set, and multiple sets of tear-off regions 43 are repeatedly disposed in the longitudinal direction of the paper 10. In the paper 10, each of the detection holes 41 corresponds to a set of (five) tear-off regions 43, and multiple sets, each including a single detection hole 41 and five tear-off regions 43, are repeatedly disposed in the longitudinal direction of the paper 10. The shapes, number and arrangement of tear-off regions 43 on the continuous paper may be appropriately selected according to the purpose of printed sheets, and are not limited to those shown in the figures. For example, the paper 10 may include only one tear-off region 43 in the width direction thereof, and the detection holes 41 and the tear-off regions 43 may be alternately disposed in the longitudinal direction of the paper 10.

As shown in FIG. 2A, not a set of tear-off regions 43, but a detection hole 41, is usually formed at the leading edge 10E of the paper. However, if the paper 10 is cut in the middle of the tear-off regions 43, as shown in FIG. 2B, incomplete tear-off regions 43a are disposed at the leading edge 10E of the paper, and next to them, a detection hole 41 and complete tear-off regions 43b are disposed in this order.

The ribbon supply roller 4A and the ribbon take-up roller 4B shown in FIG. 1 hold the ink ribbon 4 thereon, and are driven by the ink-ribbon driver 24 to rotate around their center axes. By this driving, the ink ribbon 4 is unwound from the ribbon supply roller 4A, is transported via the ribbon guide roller 15 and passed between the thermal head 3 and the platen roller 9, and is wound on the ribbon take-up roller 4B.

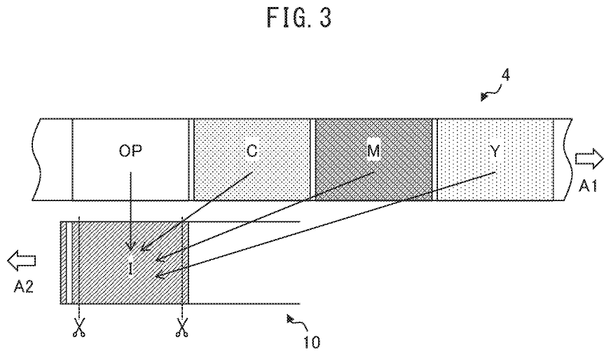

FIG. 3 shows an example of the ink ribbon 4. The ink ribbon 4 is a belt-like sheet including, for example, color ink regions of yellow Y, magenta M and cyan C and regions of overcoat OP repeatedly disposed in the same order in the longitudinal direction thereof overcoat OP is a protective material for enhancing light resistance and abrasion resistance of printed sheets. The ink ribbon 4 is available in various sizes, the size of each ink region being, for example, 6×4 inches or 6×8 inches, and thus the printer 1 is equipped with an ink ribbon 4 matching the image size to be formed. The colors of ink are not limited to the above three colors, and may be one, two, or four or more colors; however, two or more colors are necessary to form a color image.

The thermal head 3 shown in FIG. 1 is disposed so as to face the platen roller 9, and is movable relative to the platen roller 9. The thermal head 3 is pressed against the platen roller 9 with the ink ribbon 4 and the paper 10 sandwiched therebetween, and heats internal heating elements to transfer the ink of each color and overcoat OP from the ink ribbon 4 onto the paper 10. The thermal head 3 includes a mechanism matching the type of the printer, such as a dye-sublimation printer or a thermal wax printer.

As shown in FIG. 3, at the time of printing, the printer 1 first transfers yellow Y while transporting the ink ribbon 4 and the paper 10 in the direction of arrow A1, and next, temporarily transports the paper 10 in the direction of arrow A2, and then transfers magenta M while transporting the ink ribbon 4 and the paper 10 in the direction of arrow A1 again. The direction of arrow A1 is a direction toward the rolled-paper holder 2 and the ribbon take-up roller 4B (backward direction), and that of arrow A2 is a direction toward the exit port 6 (forward direction). In this way, the printer 1 sequentially transfers the color ink of the ink ribbon 4 onto the same region on the paper 10 by moving the paper 10 back and forth relative to the thermal head 3, thereby forming an image I, and further transfers overcoat OP thereon to form a protective layer on the image I.

The paper sensor 8 shown in FIG. 1 is a sensor (e.g., an infrared sensor) for detecting the detection holes 41 on the paper 10 and the leading edge 10E (with respect to the discharging direction) of the paper, and is disposed between the thermal head 3 and the platen roller 9 and the exit roller 14 in the transport path of the paper 10. The paper sensor 8 may by a reflective sensor which emits light toward the paper 10 and receives light reflected therefrom, or a transmissive sensor which emits light toward the paper 10 and receives light transmitted therethrough.

The grip roller 17 and the pinch roller 18 transport the paper 10 by sandwiching it therebetween. The grip roller 17 is driven by the paper driver 22 to rotate either in the forward direction in which the paper 10 is fed out or in the backward direction in which it is rewound. The pinch roller 18 is rotated by being driven by the grip roller 17. When transporting the paper 10, the pinch roller 18 is pressed against the grip roller 17 to hold the paper 10 between it and the grip roller 17, and when not transporting the paper 10, the pinch roller 18 is separated from the grip roller 17 to release the paper 10.

The exit roller 14 transports the paper 10 unwound from the rolled paper holder 2 and passes between the thermal head 3 and the platen roller 9 along an exit path 13 toward the exit port 6.

The cutter 5, which is an example of the cutter, cuts the trailing edge (upstream edge with respect to the discharging direction, i.e., the direction of arrow A2) of a printed portion (image I) of the paper 10 whose leading edge 10E has passed the exit path 13 and fed out of the printer 1 from the exit port 6. For example, as shown in FIG. 3, the cutter 5 cuts the leading edge of the paper 10, and further cuts the trailing edge of the image I on the paper 10 after the paper 10 is transported in the direction of arrow A2. In this way, the printed portion of the paper 10 is discharged as a printed sheet out of the printer 1 through the exit port 6 provided in a front face 12 of the printer 1. The cutter 5 is disposed in the exit path 13 just before the exit port 6, and is driven by the cutter driver 25.

The controller 20 is constructed from a microcomputer including a CPU and a memory, and controls the entire operation of the printer 1. In particular, the controller 20 controls the paper driver 22 transporting the paper 10, using a detection hole 41 on the paper 10 detected by the paper sensor 8 as a reference position, thereby positioning the paper 10 relative to the position of the thermal head 3 at the time of printing and relative to the position of the cutter 5 at the time of cutting. In general, the positions of the tear-off regions 43 on the paper and the positional relationship between the detection holes 41 and the tear-off regions 43 differ between types of paper, and in the printer 1, information on this positional relationship is stored in a built-in memory (e.g., the data memory 21). The controller 20 refers to the information on the positional relationship regarding the paper 10 to be used, and controls the operation of the paper driver 22 in accordance with the necessary amount of transport determined by this positional relationship.

The data memory 21, which is an example of the memory, stores information necessary for the operation of the printer 1. The data memory 21 stores image data received from a host computer via the communication interface 26, and information on the positional relationship between the detection holes 41 and the tear-off regions 43 on the paper 10 for each of different types of paper 10 which are usable in the printer 1. As this information on the positional relationship, the data memory 21 stores, for example, the following:
the distance L1 from the leading edge 10E of the paper to the detection hole 41 which is the closest to the leading edge 10E,
the distance L2 in the longitudinal direction of the paper 10 from the trailing edge (upstream edge with respect to the discharging direction of the paper 10) of a detection hole 41 to the trailing edges of the tear-off regions 43 corresponding to this detection hole 41, and
the pitch L3 of the detection holes 41 in the longitudinal direction of the paper 10, which are shown in FIG. 2A.

Actually, the pitch of the tear-off regions 43 in the longitudinal direction of the paper 10 is set to the same as that of the ink regions of the ink ribbon 4. For this reason, the above information (L1 to L3) on the positional relationship between the detection holes 41 and the tear-off regions 43 may be stored in an RFID (IC tag) attached to the ink ribbon 4. However, since such an RFID of an ink ribbon 4 has a limited storage capacity, the RFID may store information on types of paper which are usable with the ink ribbon 4, and the memory in the printer 1 may store a correspondence between the types of paper and the information (L1 to L3) on the positional relationship.

The paper driver 22 is a stepper motor for driving the grip roller 17 and the rolled-paper holder 2, and drives them to rotate either in the direction in which the paper 10 is fed out or in the direction in which it is rewound, under the control of the controller 20. In the printer 1, the amount of transport from when the paper 10 is positioned relative to the thermal head 3 at the time of printing to when it is cut by the cutter 5 is controlled by only the number of steps of the stepper motor. The rolled-paper holder 2, the grip roller 17 and the paper driver 22 are an example of the transporting device configured to transport continuous paper.

The head driver 23 drives the thermal head 3 in accordance with image data to form an image on the paper 10. The thermal head 3, the platen roller 9 and the head driver 23 are an example of the printing device.

The ink ribbon driver 24 is a motor for driving the ribbon supply roller 4A and the ribbon take-up roller 4B, and drives them to rotate either in the direction in which the ink ribbon 4 is wound on the ribbon take-up roller 4B or in the direction in which the ink ribbon 4 is rewound on the ribbon supply roller 4A. The cutter driver 25 is a motor for driving the cutter 5. The communication interface 26 receives image data to be printed from the host computer, for example, via a communication cable.

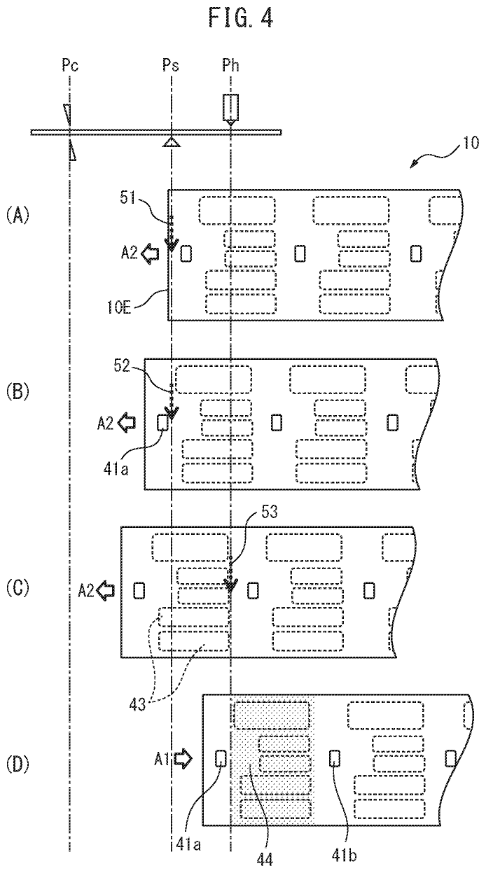

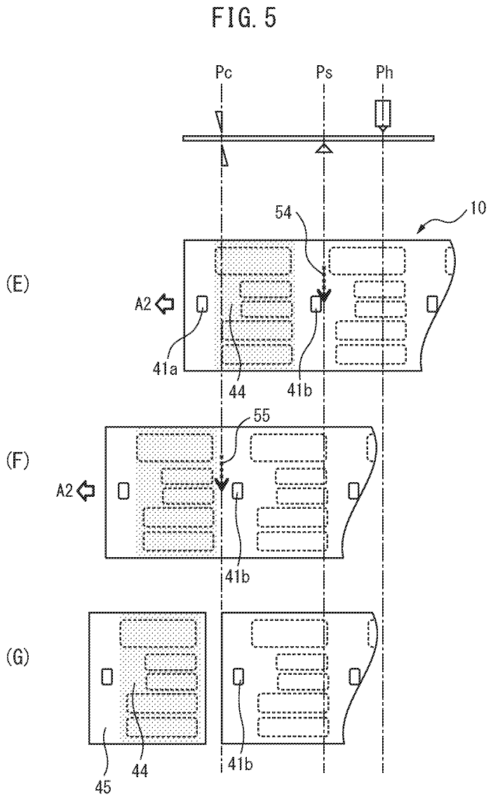

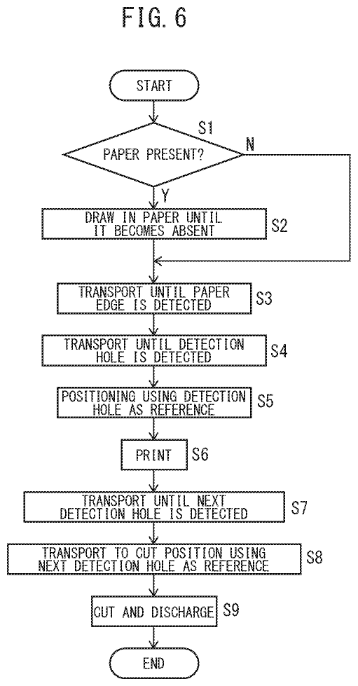

FIGS. 4 and 5 show a first operational example of the printer 1. FIG. 6 is a flowchart showing the first operational example of the printer 1. The illustrated flow is executed by the CPU included in the controller 20 in accordance with a program stored in advance in the memory included in the controller 20. Reference numerals Ph, Ps and Pc in FIGS. 4 and 5 indicate the positions of the thermal head 3, the paper sensor 8 and the cutter 5 in the transport path of the paper 10, respectively. Hereinafter, these positions will be referred to as the head position Ph, sensor position Ps and cutter position Pc.

Upon receiving a print instruction and image data to be printed from the host computer, the controller 20 first determines whether or not the output of the paper sensor 8 is at a level indicating “paper present” (the paper sensor 8 has detected the paper 10) (S1). If the paper sensor 8 detects the paper 10 (Yes in S), the controller 20 causes the paper driver 22 to rewind (draw in) the paper 10 onto the rolled-paper holder 2 until the output of the paper sensor 8 changes to a level indicating “paper absent” (S2). If the paper sensor 8 does not detect the paper 10 (No in S1), the process proceeds to S3 without executing S2. In other words, by the step of S2, the controller 20 interprets that the leading edge 10E of the paper is not beyond the sensor position Ps and that the paper 10 is not detected by the paper sensor 8.

Then, as indicated by arrow 51 in (A) of FIG. 4, the controller 20 causes the paper 10 to be transported in the discharging direction (the direction of arrow A2) until the paper sensor 8 detects the leading edge 10E of the paper (S3). Further, as indicated by arrow 52 in (B) of FIG. 4, the controller 20 causes the paper 10 to be transported in the direction of arrow A2 until the paper sensor 8 detects the detection hole 41a which is the closest to the leading edge 10E of the paper (S4). At this time, the output of the paper sensor 8 temporarily changes from the level of “paper present” to that of “paper absent,” and then to that of “paper present” again by the passage of the detection hole 41a through the sensor position Ps.

Subsequently, the controller 20 further causes the paper 10 to be transported in the direction of arrow A2 using the trailing edge (upstream edge with respect to the direction of arrow A2) of the detection hole 41a as a reference, thereby positioning the trailing edges of the target tear-off regions 43 of the paper 10, which are the print starting position on the paper 10, at the head position Ph, as indicated by arrow 53 in (C) of FIG. 4 (S5). The amount of this transport is determined as a function of the distance along the transport path of the paper 10 between the sensor position Ps and the head position Ph and the distance L2 from the trailing edge of the detection hole 41a to the trailing edges of the target tear-off regions 43.

After the positioning, as shown in (D) of FIG. 4, the controller 20 causes the head driver 23 to print while the paper 10 is drawn in the direction of arrow A1 (S6). At this time, the controller 20 first causes a yellow image to be formed on the tear-off regions 43 while the paper 10 is transported in the direction of arrow A1 and after the printing in yellow, the controller 20 causes the paper 10 to be transported in the direction of arrow A2 by the same length as the amount of the preceding transport, thereby replacing the trailing edges of the tear-off regions 43 at the head position Ph. Then, the controller 20 causes a magenta image to be formed on the same tear-off regions 43 while the paper 10 is transported in the direction of arrow A1 again. In this way, every time the paper 10 is transported in the direction of arrow A1, the thermal head 3 prints in YMC colors on the same tear-off regions 43 to form a color image, and further transfers overcoat OP thereon to form a protective layer.

Reference numeral 44 in (D) of FIG. 4 indicates a printed region. As shown in the figure, the printed region 44 need not be completely the same as the tear-off regions 43, and may be that region across the paper 10 which covers the target tear-off regions 43 and has a certain length in the longitudinal direction of the paper 10. Accordingly, the print starting position on the paper 10 after the positioning in S5 may not be completely the same as the trailing edges of the tear-off regions 43, and may be upstream of the trailing edges of the tear-off regions 43 with respect to the direction of arrow A2.

Subsequently, as indicated by arrow 54 in (E) of FIG. 5, the controller 20 causes the paper 10 to be transported in the direction of arrow A2 until the paper sensor 8 detects the detection hole 41b which is next to the detection hole 41a (the second detection hole from the leading edge 10E of the paper) (S7).

The controller 20 further causes the paper 10 to be transported in the direction of arrow A2 using the trailing edge of the next detection hole 41b as a reference, thereby causing the trailing edge of the printed region 44 on the paper 10 to be transported to the cutter position Pc, as indicated by arrow 55 in (F) of FIG. 5 (S8). In other words, the controller 20 causes the paper 10 to be positioned relative to the cutter position Pc so that the paper 10 is cut between the printed region 44 and the next detection hole 41b. The amount of this transport is determined as a function of the distance between the sensor position Ps and the cutter position Pc along the transport path of the paper 10 and the distance (same as the distance L1) from the trailing edge of the next detection hole 41b to that of the printed region 44.

Then, as shown in (G) of FIG. 5, the controller 20 drives the cutter driver 25 so that the cutter 5 cuts the paper 10, thereby discharging a printed sheet 45 out of the printer 1 (S9). This completes the first operational example of the printer 1.

In the first operational example, the paper sensor 8 detecting the leading edge 10E of the paper also detects the detection holes 41, and the tear-off regions 43 are positioned at the head position Ph using the edge of a detection hole 41 as a reference; this makes it possible to accurately print on the tear-off regions 43. In the printer 1, since transport in the direction of arrow A1 and transport in the direction of arrow A2 during printing are based on the same number of steps of the stepper motor, displacement between YMC color images does not occur when they are superposed. Further, each of the detection holes 41 is closer to the leading edge 10E of the paper than the corresponding tear-off regions 43, and after a detection hole 41 is detected, the printer 1 prints on the next tear-off regions 43 corresponding to this detection hole 41. Thus, even if there are incomplete tear-off regions 43a at the leading edge 10E of the paper as shown in FIG. 2B, the printer 1 can skip printing on them and appropriately print on the next complete tear-off regions 43b.

Transport in the direction of arrow A2 in which the paper 10 is fed out is extrusion of the paper 10, and the paper 10 drawn out from the rolled-paper holder 2 is curled; thus, when the paper 10 is fed out, the leading edge 10E of the paper comes into contact with various portions of the printer 1 in the transport path. If the leading edge 10E of the paper becomes stuck due to this contact, the paper 10 slackens and detection timings of the detection holes 41 may vary. Accordingly, when a detection hole 41 is detected in S4, the paper 10 may be fed out excessively in the direction of arrow A2 even after a detection hole 41 is temporarily detected, and then transport may be stopped and a detection hole 41 (point where the output of the paper sensor 8 changes from the level of “paper present” to that of “paper absent”) may be detected again while the paper 10 is drawn in the direction of arrow A1. Detecting a detection hole 41 while the paper 10 is drawn may reduce slack in the paper 10 and variations in detection timing. Marks on the paper 10, such as the detection holes 41, are more easily detected as the size thereof increases; however, it is difficult to enlarge the detection holes 41 due to constraints imposed on the design of the tear-off regions 43 and cost. Thus, if the paper sensor 8 cannot detect a level change caused by the passage of a detection hole 41 due to some cause, such as meandering of the paper 10, an error occurs and a required printed sheet cannot be outputted. Hereinafter, a second operational example will be described wherein in general, print regions are positioned at the head position Ph using a detection hole 41 as a reference position (this operation is referred to as a detection-hole detecting mode), but if no detection hole can be detected, they are positioned at the head position Ph using the leading edge 10E of the paper as a reference (this operation is referred to as a paper-edge detecting mode).

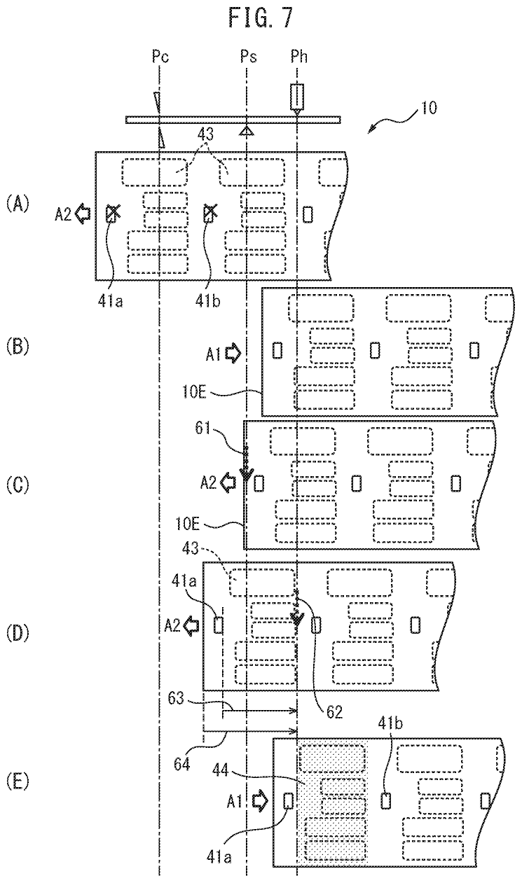

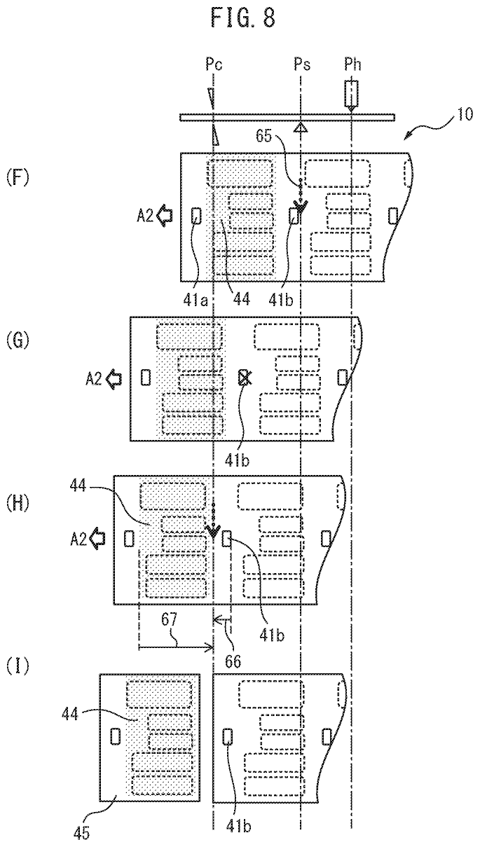

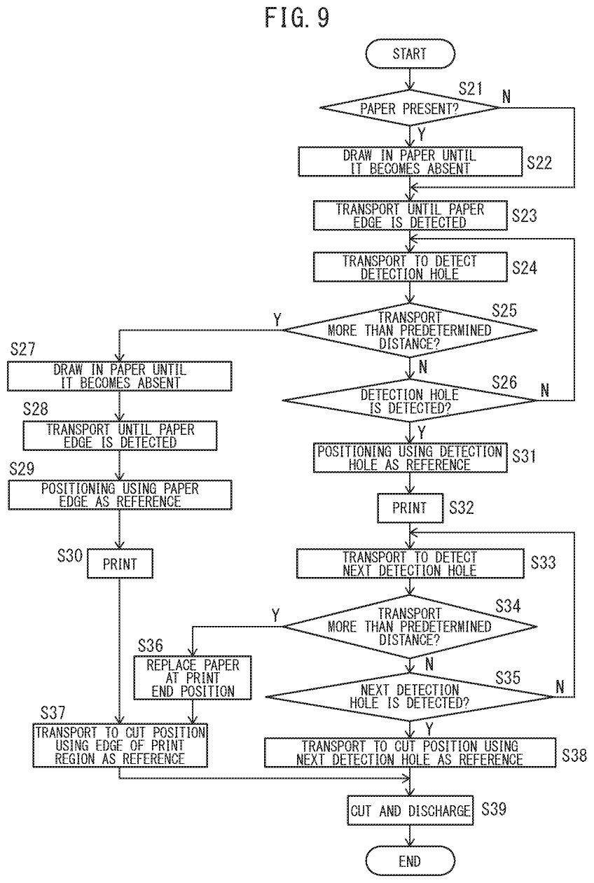

FIGS. 7 and 8 show a second operational example of the printer 1. FIG. 9 is a flowchart showing the second operational example of the printer 1. In the second operational example, the printer 1 operates in the detection-hole detecting mode at the start of printing, and switches the operating mode to the paper-edge detecting mode if no detection hole can be detected.

At the start of printing, the controller 20 first determines whether or not the paper sensor 8 has detected the paper 10 (paper present) (S21); if the paper is present (Yes in S21), the controller 20 causes the paper 10 to be drawn until it becomes absent (S22), and then causes the paper 10 to be transported until the paper sensor 8 detects the leading edge 10E of the paper (S23). The process of S21 to S23 is the same as that of S1 to S3 in the first operational example.

Then, in order to detect the first detection hole 41a, the controller 20 causes the paper 10 to be transported in the direction of arrow A2 (S24). If no detection hole 41a is detected even after the paper driver 22 transports the paper 10 by a predetermined distance (if the loop of S25 (No), S26 (No) and S24 is repeated and then the result in S25 becomes Yes), the operating mode of the printer 1 is switched to the paper-edge detecting mode, and the process proceeds to S27. In (A) of FIG. 7, the fact that the two detection holes 41a and 41b have passed through the sensor position Ps without being detected is represented by symbols x. The only requirement of the predetermined distance in S25 is to be longer than the pitch L3 of the detection holes 41 in the longitudinal direction of the paper 10.

If the paper 10 is transported by the predetermined distance without the detection hole 41a being detected (Yes in S25), the controller 20 causes the paper 10 to be drawn in the direction of arrow A1 until the leading edge 10E of the paper passes through the sensor position Ps and the paper becomes absent (S27), as shown in (B) of FIG. 7. Then, as indicated by arrow 61 in (C) of FIG. 7, the controller 20 causes the paper 10 to be transported in the direction of arrow A2 until the paper sensor 8 detects the leading edge 10E of the paper (S28). The process of S27 and S28 is the same as that of S22 and S23.

Subsequently, the controller 20 further causes the paper 10 to be transported in the direction of arrow A2 using the leading edge 10E of the paper as a reference, thereby positioning the trailing edges of the target tear-off regions 43 of the paper 10, which are the print starting position on the paper 10, at the head position Ph, as indicated by arrow 62 in (D) of FIG. 7 (S29). The amount of this transport corresponds to the length of arrow 64, and is determined as a function of the distance along the transport path of the paper 10 between the sensor position Ps and the head position Ph, the distance L1 from the leading edge 10E of the paper to the detection hole 41a, and the distance L2 from the trailing edge of the detection hole 41a to the trailing edges of the target tear-off regions 43. In other words, the controller 20 causes the paper 10 to be transported by a length from the leading edge 10E of the paper to a position where the trailing edges of the first set of tear-off regions 43 should be. After the positioning, as shown in (E) of FIG. 7, the controller 20 causes the head driver 23 to print while the paper 10 is drawn in the direction of arrow A1 (S30). The process of S30 is the same as that of S6 in the first operational example.

If the detection hole 41a is detected before the paper 10 is transported by the predetermined distance (Yes in S26), the controller 20 further causes the paper 10 to be transported in the direction of arrow A2 (arrow 63 in (D) of FIG. 7) using the trailing edge of the detection hole 41a as a reference, thereby positioning the trailing edges of the target tear-off regions 43 at the head position Ph (S31). After the positioning, as shown in (E) of FIG. 7, the controller 20 causes the head driver 23 to print while the paper 10 is drawn in the direction of arrow A1 (S32). The process of S32 is the same as that of S6 in the first operational example.

After the printing in S32, in order to detect the next detection hole 41b, the controller 20 causes the paper 10 to be transported in the direction of arrow A2 (S33). If the next detection hole 41b is not detected even after the paper driver 22 transports the paper 10 by a predetermined distance (if the loop of S34 (No), S35 (No) and S33 is repeated and then the result in S34 becomes Yes), the operating mode of the printer 1 is switched to the paper-edge detecting mode, and the process proceeds to S36. In (G) of FIG. 8, the fact that the next detection hole 41b has passed through the sensor position Ps without being detected is represented by a symbol x. The only requirement of the predetermined distance in S34 is also to be longer than the pitch L3 of the detection holes 41 in the longitudinal direction of the paper 10.

If the paper 10 is transported by the predetermined distance without the next detection hole 41b being detected (Yes in S34), the controller 20 causes the paper 10 to be drawn in the direction of arrow A1 by the same length as the amount of transport in S33, thereby replacing the paper 10 at the position where it was at the end of printing in S32 (S36).

After S30 or S36, the controller 20 further causes the paper 10 to be transported in the direction of arrow A2 using the leading edge (downstream edge with respect to the direction of arrow A2) of the printed region 44 as a reference, thereby causing the trailing edge of the printed region 44 on the paper 10 to be transported to the cutter position Pc, as shown in (H) of FIG. 8 (S37). The amount of this transport corresponds to the length of arrow 67, and is determined as a function of the distance along the transport path of the paper 10 between the head position Ph and the cutter position Pc and the length of the printed region 44 in the transport direction of the paper 10.

As indicated by arrow 65 in (F) of FIG. 8, if the next detection hole 41b is detected before the paper 10 is transported by the predetermined distance (Yes in S35), the controller 20 further causes the paper 10 to be transported in the direction of arrow A2 (arrow 66 in (D) of FIG. 8) using the trailing edge of the next detection hole 41b as a reference, thereby causing the trailing edge of the printed region 44 on the paper 10 to be transported to the cutter position Pc (S38). The process of S38 is the same as that of S8 in the first operational example.

After S37 or S38, as shown in (I) of FIG. 8, the controller 20 drives the cutter driver 25 so that the cutter 5 cuts the paper 10, thereby discharging a printed sheet 45 out of the printer 1 (S39). This completes the second operational example of the printer 1.

In the second operational example, even if no detection hole 41 can be detected, no error occurs and printing is performed on a region where the tear-off regions 43 should be, and then the paper 10 is cut at a position which should be between the printed region 44 and the next detection hole 41b; and thereby, a printed sheet can be outputted.

In the second operational example, if no detection hole 41 is detected even after the paper driver 22 transports the paper 10 by the predetermined distance (if the detection of a detection hole 41 has failed and the process of S27 to S30 or that of S36 and S37 has been performed), the detection of a detection hole 41 may be omitted and the process may proceed straight from S23 to S29 at the time of printing the second and subsequent printed sheet, and the printer may keep operating in the paper-edge detecting mode. Further, in the second operational example, if the detection of a detection hole 41 has failed, the controller 20 may notify the host computer via the communication interface 26 that printing has been performed without any detection hole 41 being detected. Then, a user of the printer 1 will be notified that printing has been performed without any detection hole 41 being detected, thus attracting the attention of the user so as to reconfirm conditions such as the state of installation of the paper 10 and the output level of the paper sensor 8.

The above control in the first and second operational examples does not depend on the print scheme, and is thus also applicable to printers other than thermal transfer printers. The printer performing the above control may be of any type, such as an inkjet printer, an electrophotographic printer, a dot-impact printer or a dye-sublimation printer, as long as it uses continuous paper, and any print scheme may be used without limitation.

1. A printer comprising:
a transporting device configured to transport belt-like continuous paper including predefined print regions disposed in a longitudinal direction thereof;
a detector configured to detect marks disposed on the continuous paper in the longitudinal direction, the marks respectively corresponding to the print regions;
a printing device configured to print on the print regions of the continuous paper;
a cutter configured to cut the continuous paper at an edge of the print regions to discharge a printed portion of the continuous paper as a printed sheet, the edge being a trailing edge with respect to a discharging direction of the continuous paper;
a memory configured to store information on a positional relationship between the marks and the print regions on the continuous paper; and
a processor configured to control the transporting device so that the transporting device transports the continuous paper in accordance with the positional relationship using a detected one of the marks as a reference position, thereby positioning one of the print regions at the printing device, and then repeatedly transports the continuous paper in one direction and an opposite direction by the same amount during printing,
wherein the printing device prints in a different color on the one of the print regions every time the continuous paper is transported in the one direction, thereby forming a color image.

2. The printer according to claim 1, wherein
the memory is configured to store information on the positional relationship for each of different types of the continuous paper, the positional relationship depending on shapes, sizes or arrangement of the print regions on the continuous paper, and
the controller is configured to refer to the information on the positional relationship of the continuous paper transported by the transporting device to control operation of the transporting device.

3. The printer according to claim 1, wherein after printing is performed by the printing device, the controller further causes the transporting device to transport the continuous paper in accordance with the positional relationship using a newly detected mark as a reference position, thereby positioning the trailing edge of the one of the print regions at the cutter.

4. The printer according to claim 1, wherein
the detector is also capable of detecting an edge of the continuous paper, the edge being a leading edge with respect to the discharging direction, and
if none of the marks is detected while the transporting device transports the continuous paper by a predetermined amount, the controller causes the transporting device to transport the continuous paper in accordance with the positional relationship using the leading edge of the continuous paper as a reference position, thereby positioning one of the print regions at the printing device.

5. The printer according to claim 4, wherein after printing is performed by the printing device, the controller further causes the transporting device to transport the continuous paper in accordance with the positional relationship using an edge of the one of the print regions as a reference position, thereby positioning the trailing edge of the one of the print regions at the cutter, regardless of whether or not a mark has been newly detected.

6. The printer according to claim 3, wherein if none of the marks is detected while the transporting device transports the continuous paper by a predetermined amount, the controller causes the transporting device to transport the continuous paper in accordance with the positional relationship using an edge of the one of the print regions as a reference position, thereby positioning the trailing edge of the one of the print regions at the cutter.

7. The printer according to claim 4, wherein if none of the marks is detected while the transporting device transports the continuous paper by the predetermined amount, the controller notifies a user that printing has been performed without a mark being detected.
